(19) United States
(12) Patent Application Publication
(10) Pub. No.: US 2001/0019198 A1
(43) Pub. Date: Sep. 6, 2001

(54) Snow-gliding apparatus

(76) Inventor: Andrew Wolf, Gresham, OR (US)

Correspondence Address: Kolisch, Hartwell, Dickinson,, McCormack & Heuser, 200 Pacific Building, 520 S.W. Yamhill Street, Portland, OR, 97204, US

(21) Appl. No.: 09/798,502

(22) Filed: Mar. 1, 2001

Related U.S. Application Data
(63) Continuation-in-part of application No. 09/518,231, filed on Mar. 2, 2000.

(51) Int. Cl. B62B 9/04

(52) U.S. Cl. 280/609; 280/14.21

(57) ABSTRACT

A gliding apparatus for use in snow is provided. The apparatus typically includes an elongate member including an intermediate portion positioned between a pair of longitudinally opposed upturned end portions. The elongate member includes a bottom surface configured to glide over snow and a laterally upwardly curved surface. The apparatus further includes a traction layer positioned above the elongate member. The traction layer is typically a pliant foam layer. The apparatus may also include a translucent layer through which indicia is viewable, beveled edges, stringers, and/or an elongate member with layers of varying stiffness.

### CROSS-REFERENCE TO RELATED APPLICATIONS

This application is a continuation-in-part of U.S. patent application Ser. No. 09/518,231, filed Mar. 2, 2000.

### BACKGROUND OF THE INVENTION

The sports of skateboarding and snowboarding have reached new heights of popularity in recent years. A skateboard includes a board with wheels attached to the underside, and is designed for riding on a sidewalk or in a specially designed skate park. A snowboard includes a board with a waxed underside and bindings for securing the feet of a rider to the snowboard, and is designed primarily for riding on a snow-covered slope or in a specially designed snow park.

Riding a skateboard is similar to riding a snowboard in that the rider assumes a sideways stance on both types of boards. However, one primary difference is that, in skateboard riding, the rider's feet are free to leave the surface of the skateboard, whereas in snowboarding, the rider's feet remain securely attached to the snowboard. Skateboard riding has evolved to include a host of well known tricks such as ollies, kickflips, shovits, etc., which take advantage of the ability to remove the rider's feet temporarily from the skateboard during performance of the trick. These tricks are not able to be performed on current snowboards because the bindings prevent the rider's feet from leaving the snowboard.

One problem with current skateboards is that they are unable to be ridden successfully on snow, because the wheels of the skateboards dig into the snow and cause the skateboards to stop suddenly. Attempts to ride skateboards on snow generally result in crashes. For riders who reside in cold-weather climates, this renders skateboards unusable outdoors during the snowy season, which may last for many months.

It would be desirable to provide an apparatus that is capable of being ridden in the snow, and that is configured to allow temporary removal of a rider's feet from the apparatus, to enable a rider to perform a wide variety of maneuvers.

### SUMMARY OF THE INVENTION

A gliding apparatus for use in snow is provided. The apparatus typically includes an elongate member including an intermediate portion positioned between a pair of longitudinally opposed upturned end portions. The elongate member includes a bottom surface configured to glide over snow and a laterally upwardly curved surface. The apparatus further includes a traction layer positioned above the elongate member. The traction layer is typically a pliant foam layer.

According to another aspect of the invention, a gliding apparatus is provided that includes an elongate member having an intermediate portion positioned between a pair of longitudinally opposed upturned end portions. The elongate member includes a bottom surface configured to glide over snow. The apparatus further typically includes a stringer imbedded in and extending lengthwise along the elongate member. The stringer may be made of laminated wood, or other suitable material. The apparatus may also include a traction layer positioned above the elongate member and stringer. The traction layer is typically pliant foam.

According to another aspect of the invention, the gliding apparatus may include an elongate member having an intermediate portion positioned between a pair of longitudinally opposed upturned end portions and a bottom surface configured to glide over snow, where the elongate member is formed of a first and a second layer of material, the first layer being stiffer than the second layer. The apparatus typically also includes a traction layer positioned above the elongate member. The first and second layers may be co-extruded and/or high-density polyethylene. The first layer may include a stiffener, such as talcum. The apparatus may further include a channel extending lengthwise along the bottom surface of the elongate member, the channel being configured to guide the elongate member over snow.

According to another aspect of the invention, the gliding apparatus includes an elongate member having an intermediate portion positioned between a pair of longitudinally opposed upturned end portions, the elongate member including indicia on a surface. The apparatus further typically includes a translucent layer positioned adjacent the surface such that the indicia is visible through the translucent layer. The apparatus may also include a channel extending lengthwise along a bottom surface of the elongate member, the channel being configured to guide the apparatus over snow. The indicia may be on a top surface of the elongate member and the translucent layer may be a traction layer positioned above the elongate member. Alternatively, the indicia may be on a bottom surface of the elongate member and the translucent layer may be positioned below the elongate member.

According to another aspect of the invention, the gliding apparatus may include an elongate member including an intermediate portion positioned between a pair of upturned end portions, the elongate member including a bottom surface. The apparatus may further include a plurality of substantially parallel channels extending lengthwise along the bottom surface of the elongate member, adjacent channels being separated by rounded ridges extending therebetween.

According to another aspect of the invention, the gliding apparatus includes an elongate member including an intermediate portion between a pair of upturned end portions, the elongate member including a bottom surface configured to glide over snow and a pair of opposed side edges, each of which tapers to a point at an angle of between about 30- and 60-degrees. In one embodiment of the invention, the angle may be formed between about 40- and 50-degrees, and in a particularly preferred embodiment, 45 degrees. The apparatus further typically includes a traction layer positioned above the elongate member.

### BRIEF DESCRIPTION OF THE DRAWINGS

FIG. 1 is an isometric view of a snow-gliding apparatus according to one exemplary embodiment of the present invention.

FIG. 2 is a side view of the embodiment of FIG. 1.

FIG. 3 is a bottom view of the embodiment of FIG. 1.

FIG. 4 is a bottom view of a snow-gliding apparatus according to another embodiment of the invention.

FIG. 5 is a front end view of the embodiment of FIG. 1.

FIG. 6 is a front end view of the embodiment of FIG. 4.

FIG. 7 is a cross-sectional view of the embodiment of FIG. 1, taken along line 7-7 of FIG. 3.

FIG. 8 is a cross-sectional view of the embodiment of FIG. 4, taken along line 8-8.

FIG. 9 is a cross-sectional view of a snow-gliding apparatus according to another embodiment of the invention including two channel groups and a traction member with a concave top surface.

FIG. 10 is a cross-sectional view of a snow-gliding apparatus according to another embodiment of the invention including, three channel groups and a traction member with a concave top surface.

FIG. 11 is an isometric view of a snow-gliding apparatus according to another embodiment of the present invention, including a laterally curved upper surface.

FIG. 12 is a bottom view of the snow-gliding apparatus of FIG. 11.

FIG. 13 is a cross sectional view of the snow-gliding apparatus of FIG. 11.

FIG. 14 is an isometric view of a snow-gliding apparatus according to another embodiment of the present invention, including a translucent top and bottom surfaces through which indicia may be viewed.

FIG. 15 is a bottom view of the snow-gliding apparatus of FIG. 14.

FIG. 16 is a cross sectional view of the snow-gliding apparatus of FIG. 16

FIG. 17 is an isometric view of a snow-gliding apparatus according to another embodiment of the present invention, including a pair of stringers running along the length of the apparatus.

FIG. 18 is a cross sectional view of the snow-gliding apparatus of FIG. 17.

FIG. 19 is a cross sectional view of another embodiment of a snow-gliding apparatus according to the present invention, including rounded ridges and channels.

### DETAILED DESCRIPTION OF THE PREFERRED EMBODIMENT

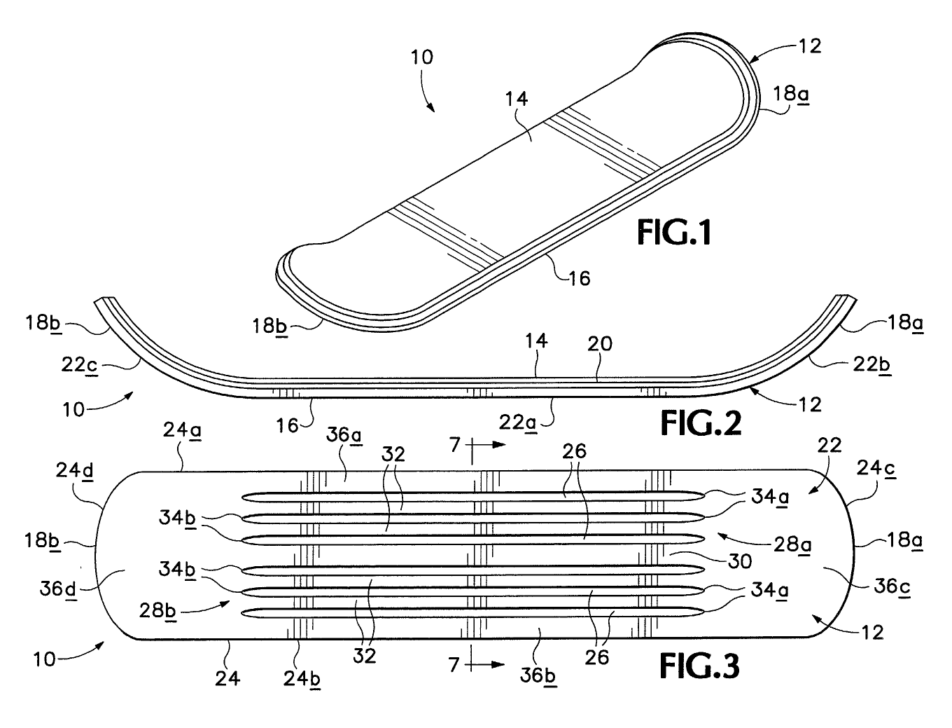

Referring initially to FIGS. 1-3, a snow-gliding apparatus according to the present invention is shown generally at 10. Snow-gliding apparatus 10 typically includes an elongate member 12 configured to slide over snow, and a traction member 14 configured to provide traction for the boots or shoes of a rider.

Elongate member 12 includes a substantially flat intermediate portion 16 and opposite upturned end portions 18a, 18b, also referred to as leading end portion 18a and trailing end portion 18b. Leading and trailing end portions 18a, 18b each include a respective inward end positioned adjacent a corresponding outer end of intermediate portion 16. Leading and trailing end portions 18a, 18b typically each extend outward from the intermediate portion 16 in a continuously curved shape. Alternatively, the leading and trailing end portions 18a, 18b may be polygonal, or may have another curved shape. Typically, the upturned end portions 18a, 18b are symmetric. Alternatively, the upturned end portions may be formed in different shapes.

Elongate member 12 includes a top surface 20 and a bottom surface 22. The bottom surface includes a substantially planar bottom region 22a, typically extending along a bottom side of intermediate portion 16 of the elongate member 12. It will be understood that substantially planar bottom region may include a camber. Elongate member 12 is typically made of high-density polyethylene material. Alternatively, the elongate member may be constructed partially or wholly from a translucent material such as polycarbonate or LEXAN. For example, the elongate member may include an upper layer of high density polyethylene, with a graphical design imprinted on its bottom surface, followed a lower layer of translucent material, such that the graphical design is viewable from the bottom of the elongate member through the translucent material.

Bottom surface 22 further includes a leading upturned bottom region 22b and a trailing upturned bottom region 22c, each extending along an underside of upturned end portions 18a and 18b, respectively. Typically, both leading upturned bottom region 22b and trailing upturned bottom region 22c are shaped in a continuous curve originating at an inward end of the respective upturned bottom region, which is positioned at the intersection of the respective upturned bottom region 22b, 22c and the substantially planar bottom region 22a. Alternatively, the upturned bottom regions may be straight, polygonal, or curved in another shape.

As shown in FIG. 3, elongate member 12 is surrounded by an outer edge 24, which includes left and right edges 24a, 24b and leading and trailing end edges 24c and 24d. Typically, the outer edge 24 is rounded in the region of ends edges 24c and 24d and straight in the region of side edges 24a and 24b. Alternatively, the end edges may be straight or polygonal, and/or the side edges may be curved or polygonal.

Apparatus 10 typically includes a plurality of elongate channels 26 organized into first and second channel groups 28a 28b separated by a dividing portion 30. First and second channel groups 28a, 28b are also referred to as left and right channel groups 28a, 28b, respectively. Channels 26 are separated from each other within channel groups 28a, 28b by a plurality of channel-separating portions 32. Channel groups 28a, 28b are typically positioned in an interior region of the bottom surface 22 of elongate member 12.

Each of channels 26 typically extends lengthwise along the substantially planar bottom region 22a of the bottom surface of the apparatus, from the inward end of leading end portion 18a to the inward end of trailing end portion 18b. Each channel 26 includes a pair of leading and trailing rounded end portions 34a and 34b formed at each end of the channel. Typically, elongate member 12 is formed from a flat sheet of material, which first is bent to form upturned end portions 18a, 18b and later is cut horizontally with a router or other device to form elongate channels 26. This produces rounded end portions 34a and 34b in the bends adjacent the inner end of upwardly turned end portions 18a and 18b.

Bottom surface 22 typically includes left-side and right-side surface portions 36a, 36b, and leading end and trailing end surface portions 36c and 36d. Surface portions 36a, 36b, 36c, and 36_{d} typically are smooth, and do not include channels or projections.

Channels 26 typically open to the leading end of the apparatus, as shown in FIG. 5, as well as to the trailing end of the apparatus, which typically is symmetric to the leading end shown in FIG. 5. As the apparatus passes over a snow-covered surface, snow under channels 26 is guided into the channels, while snow under substantially planar regions of bottom surface 22 is compacted. Thus, snow under channel-group dividing portion 30, channel-separating portions 32, and right-side and left-side surface portions 36a, 36b, is compacted. Snow within channels 26, if compacted at all, is not compacted so much as snow under the planar regions of bottom surface 22. This creates ridges in the snow, along which channels 26 are configured to slide. The sliding of the snow ridges within channels 26 tends to cause the apparatus to slide in a straight path, thereby making the apparatus easier to ride.

Typically, each of channel groups 28a, 28b includes three channels. It also will be appreciated that either of channel groups 28a, 28b alternatively may include one, two, four, or a greater number, of channels. In addition, while apparatus 10 typically includes two channel groups, it will be appreciated that apparatus 10 may include a single channel group, or three or more channel groups. Apparatus 10 may, for example, include a single channel group having a single channel.

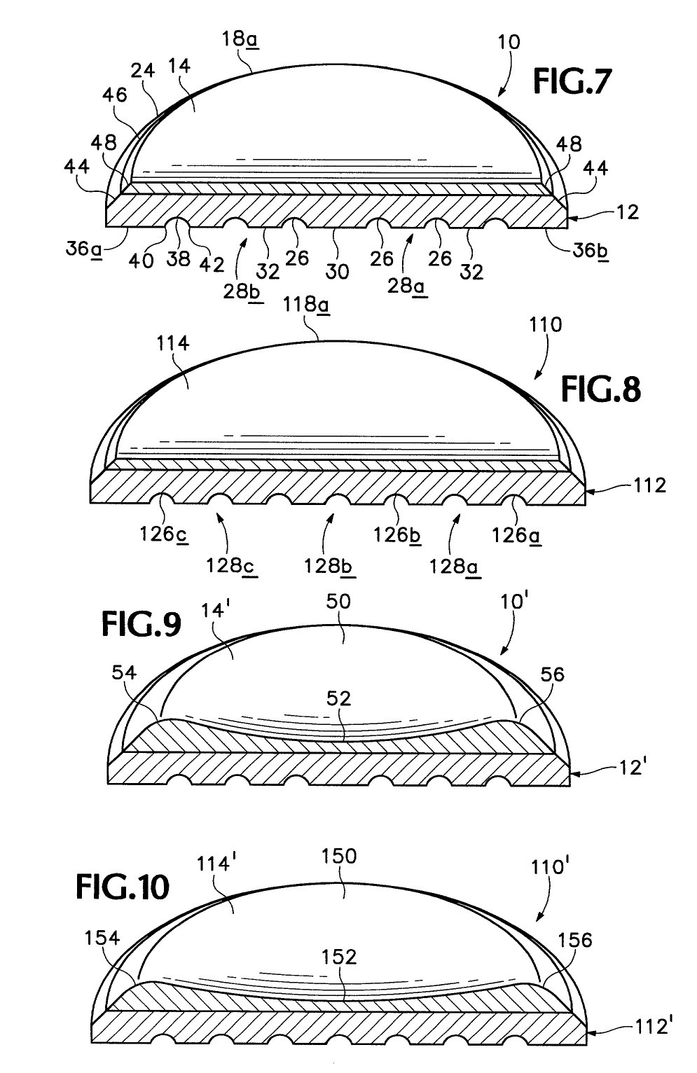

As shown in FIG. 7, each of channels 26 includes an interior surface 38 that is semi-circular (preferably hemispherical) in cross-section. Each of channels 26 further includes a pair of sharp edges 40, 42 along the intersections between the respective interior surface 38 of each channel and bottom surface 22 of elongate member 12. Sharp edges contribute to the ability of the channel to guide the apparatus over snow. Alternatively, interior surface 38 of channels 26 may be polygonal (e.g. triangular or square) or rounded according to some other predetermined curve, such as an ellipse. In addition, it will be appreciated that edges 40 and 42 may include a radius, bevel, or chamfer, and may not be sharp.

Elongate member 12 typically includes a bevel 44 along its outer edge 24. Traction member 14 also typically includes an outer edge 46 including a bevel 48. Usually, bevels 44 and 48 are formed at a common angle. Alternatively, each bevel may have a different angle. In addition, will be appreciated that elongate member 12 and traction member 14 may not include any bevel at all.

Traction member 14 typically is a pliant layer of a foam material. In one exemplary embodiment of the invention, the foam material is a closed-cell ethylene vinyl acetate material. Alternatively, virtually any other suitable pliant material may be used, including other open or closed-cell foams, or rubber materials, etc. In addition, it will be understood that the traction member may not be pliant, and may not be a foam material. Traction member 14 also typically includes an adhesive backing that adheres to elongate member 12. Alternatively, virtually any other suitable adhesive method (e.g., glues, fasteners, cements, etc.) may be used to secure traction member 14 to elongate member 12.

Traction member 14 typically is positioned on each of intermediate portion 16 and upturned end portions 18a, 18b of elongate member 12, and covers a substantial portion of top surface 20 of elongate member 12, typically all of the top surface. In the embodiment of FIG. 1, traction member 14 extends from left-side edge 24a to right-side edge 24b and from leading edge 24c to trailing edge 24d and covers all of top surface 20. Thus, a rider may step virtually anywhere on the top of the apparatus and contact the traction member 14.

Alternatively, traction member 14 may not extend entirely from left-side edge 24a to right-side edge 24b, or from leading edge 24c to trailing edge 24d, and may not be positioned on each of intermediate portion 16 and upturned end portions 18a, 18b. Typically traction member 14 is a continuous sheet of material. Alternatively, traction member 14 may be perforated or include gaps, and may not be continuous.

Referring to FIG. 9, a snow-gliding apparatus according to another embodiment of the invention is shown generally at 10′. Except as described below, the above description of apparatus 10 applies equally to apparatus 10′, and, for the sake of brevity, common elements between apparatus 10 and 10′ will not be redescribed in detail.

Apparatus 10′ includes an elongate member 12′ and a traction member 14′. Traction member 14′ has an upwardly curved top portion 50, also referred to as concave portion 50. Concave portion 50 typically includes a well 52 surrounded by ridges 54 and 56. Concave portion 50 typically extends along the length of a substantially flat intermediate portion of elongate member 12′, and into upwardly turned end portions of the elongate member 12′. Alternatively, the concave portion 50 may be contained entirely within the intermediate portion, or may extend only between a single upwardly turned end portion and the flat intermediate portion. The ridges improve the traction of the rider on the traction member 14′.

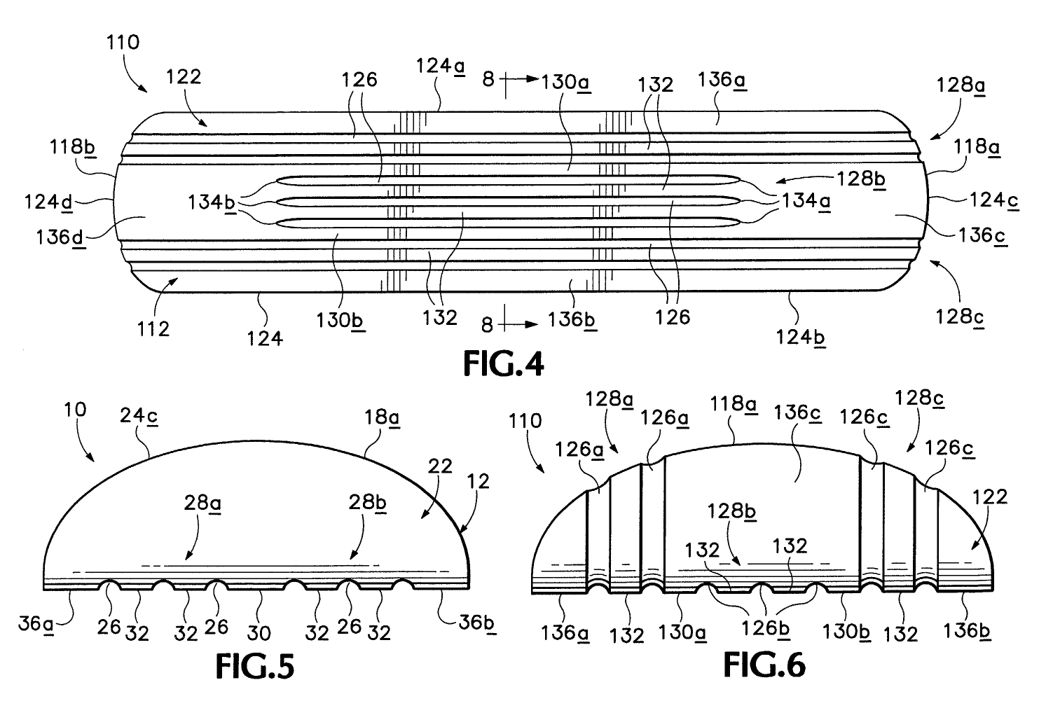

FIGS. 4, 6, and 8 show a snow-gliding apparatus according to another exemplary embodiment of the invention, indicated generally at 110. Except as described below, the above description of apparatus 10 applies equally to apparatus 110, and, for the sake of brevity, common elements between apparatus 10 and 110 will not be redescribed in detail. Corresponding elements of apparatus 10 and apparatus 110 are indicated by reference indicators that differ by 100.

Apparatus 110 includes an elongate member 112 with a bottom surface 122 and an outer edge 124 including left-side and right-side edges 124a, 124b, and leading and trailing edges 124c, 124d. Bottom surface 122 has a plurality of elongate channels 126 formed therein, which are organized into first, second, and third spaced-apart channel groups 128a, 128b, 128c, respectively.

First and third channel groups 128a, 128c are positioned on opposite sides of second channel group 128b, intermediate second channel group 128b and a respective left- or right-side edge 124a, 124b. The channels within channel groups 128a, 128b, and 128c are referred to as channels 126a, 126b, and 126c, respectively. The first, second, and third channel groups 128a 128b, and 128c also are referred to as the left channel group 128a, central channel group 128b, and right channel group 128c, respectively.

Apparatus 110 further includes a first channel-group dividing portion 130a positioned intermediate channel groups 128a and 128b and a second channel-group dividing portion 130b positioned intermediate channel groups 128b and 128c. Apparatus 110 further includes a plurality of channel-separating portions 132, each channel-separating portion 132 being positioned between an adjacent pair of channels within channel group 128a, 128b, or 128c.

Typically, left channel group 128a and right channel group 128c each includes two channels, and central channel group 128b includes three channels. Alternatively, a different predetermined number of channels may be used for each of the channel groups.

Channels 126b of central channel group 128b typically include respective leading and trailing rounded end portions 134a, 134b. The leading and trailing end portions 134a, 134b of channels 126b typically are positioned in an interior region of bottom surface 122, adjacent a respective inward end of leading or trailing end portion 1 18a, 18b. Thus, channels 126b are formed within and internal to bottom surface 122.

Bottom surface 122 typically includes left-side and right-side surface portions 136a and 136b, as well as leading-end and trailing-end surface portions 136c and 136d. Surface portions 136a, 136b, 136c and 136d typically are smooth, and do not include channels or protrusions. Each of leading-end surface portion 136c and trailing-end surface portion 136d is positioned intermediate a respective end 134a, 134b of the of channels 126b and a corresponding end edge 124c 124d of the elongate member 12, and intermediate channel groups 128a and 128c. Each of left-side and right-side surface portions 136a 136b is positioned intermediate a respective channel group 128a, 128c and a corresponding left-side or right-side edge 124a 124b.

Channels 126a , 126c of the left and right channel groups typically are longer than the channels 128b of the central channel group, and extend to intersect leading and trailing edges 124c, 124d of the apparatus. Alternatively, channels 126a and/or 126c may intersect only one of edges 124c, 124d, or may not intersect edges 124c, 124d at all. For example, the ends of channel 126a and/or 126c may terminate within an interior of upturned end portion 118a and 118b without intersecting edge 124 of the elongate member 112.

Elongate member 112 typically is formed from a flat sheet of material by first cutting channels 126a and 126c along the bottom surface of the sheet. Next, the sheet is bent at each end to form upwardly turned end portions 18a and 18b. Finally, channels 126b are cut from the sheet by passing a router or other cutting device horizontally along the bottom surface 122 of the elongate member. As the router passes from the substantially planar region of bottom surface 122 away from the elongate member, rounded end portions 134a, 134b are formed at the end of each of elongate channels 126b.

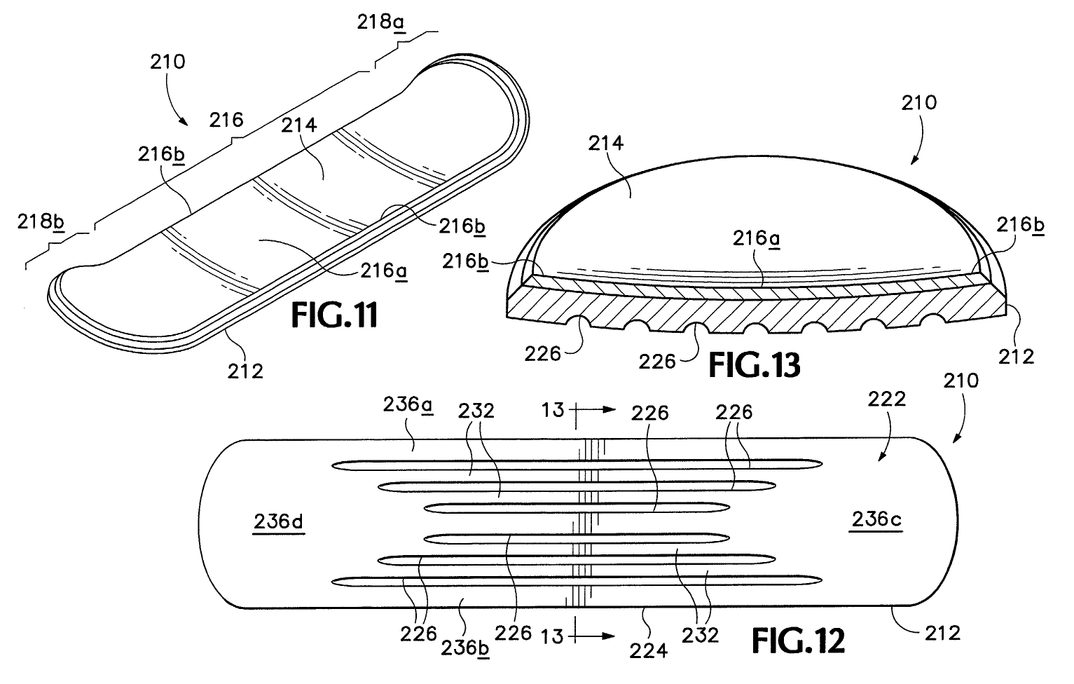

Referring to FIG. 10, a snow-gliding apparatus according to another embodiment of the invention is shown generally at 110′. Except as described below, the above description of apparatus 110 applies equally to apparatus 110′, and, for the sake of brevity, common elements between apparatus 10 and 10′ will not be redescribed in detail.

Apparatus 110′ includes an elongate member 112′ and a traction member 114′. Traction member 114′ has an upwardly curved top portion 150, also referred to as concave portion 150. Concave portion 150 typically includes a well 152 surrounded by ridges 154 and 156. Concave portion 150 typically extends the length of a substantially flat intermediate portion of elongate member 112′, and into upwardly turned end portions of the elongate member 112′. Alternatively, the concave portion 150 may be contained entirely within the intermediate portion, or may extend only between a single upwardly turned end portion and the flat intermediate portion. The ridges improve the traction of the rider on the traction member 114′.

In FIGS. 11-13, a snow-gliding apparatus according to another embodiment of the present invention is shown generally at 210. Apparatus 210 typically includes an elongate member 212 configured to slide over snow, and a traction member 214 configured to provide traction for the boots or shoes of a rider.

Apparatus 210 includes opposed, leading, and trailing upturned end portions 218a, 218b, and an intermediate portion 216. Upturned end portions 218a, 218b typically have a longitudinally curved shape similar to that shown in FIG. 2. Intermediate portion 216 typically is laterally curved, such that a central region 216a is depressed relative to side regions 216b. The laterally curved surface has two primary advantages. First, raised side regions 216b provide the rider with improved traction. Second, the upwardly curved intermediate portion makes apparatus 10 longitudinally stiffer, thereby enabling the apparatus to keep its shape after repeated use in rail slides, curb slides, etc.

As shown in FIG. 12, elongate member 212 includes a bottom surface 222, which is similar to that shown in FIG. 3, except that channels 226 formed therein terminate in a U-shaped or parabolic pattern adjacent each of upturned end portions 218a, 218b. Alternatively, the channels may be formed as shown in FIG. 3, or in another suitable pattern.

As shown in FIG. 13, both elongate member 212 and traction member 214 typically are curved laterally upward along their entire cross-sections within intermediate portion 216. Typically, both the upper and lower surfaces of each of the elongate member 212 and traction member 214 are curved upward, and the elongate member 212 and traction member 214 have a substantially continuous thickness, apart from channels 226. Alternatively, either or both of traction member 214 and elongate member 212 may have a variable cross-section, such that only an upper or lower surface of each is upwardly curved.

Turning now to FIGS. 14-16, a snow-gliding apparatus according to another embodiment of the present invention is shown generally at 310. Apparatus 310 typically includes an elongate member 312 configured to slide over snow, and a traction member 314 that is at least partially translucent such that a graphic or other indicia 313 may be viewed through the traction member. Traction member 314 typically includes a plurality of bumps or protrusions 314a for gripping the shoes or boots of a rider. Bumps 314a typically cover substantially all of an upper surface of the elongate member 312. Alternatively, the bumps may be positioned only over one or both of the upturned end portions, and in an intermediate portion 316.

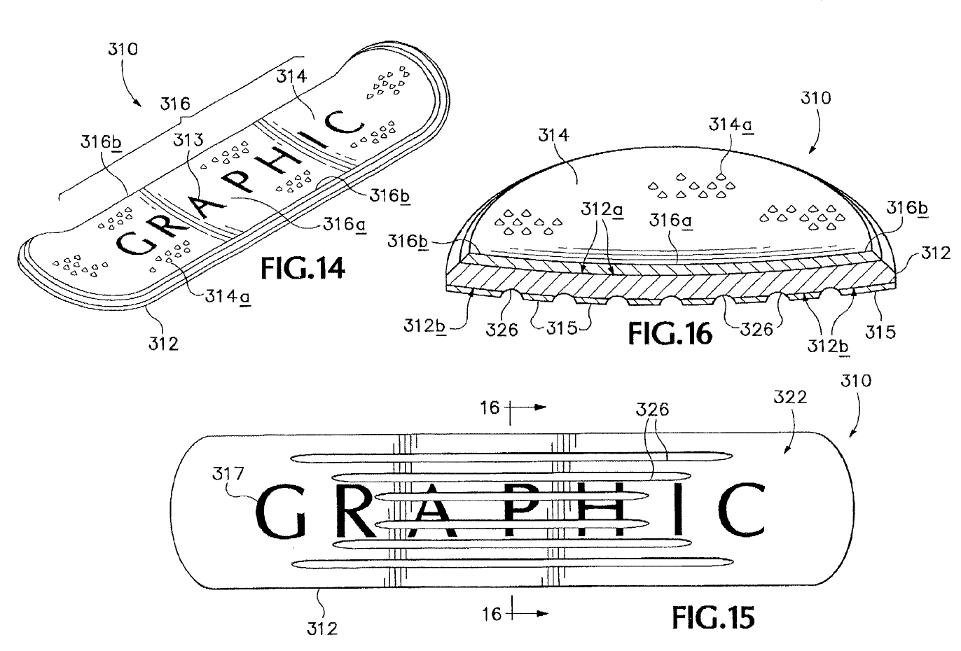

The intermediate portion 316 of apparatus 310 typically is laterally upwardly curved, such that a central region 316a is depressed relative to side regions 316b. Apparatus 310 also typically includes a translucent lower layer 315 attached adjacent a lower surface of elongate member 312. Lower layer 315 is at least partially translucent such that bottom indicia 317 is viewable through layer 315. Layer 315 may be completely transparent, or may be diffuse and/or colored. Channels 326 typically are formed through both of lower translucent layer 315 and elongate member 312. Upper indicia 313 typically is formed on an upper surface 312a of elongate member 312, while lower indicia 317 typically is formed on a lower surface 312b of elongate member 312. As shown in FIG. 15, indicia 317 typically is not printed within channels 326. Alternatively, indicia 317 may be applied within channels 326 as well as to bottom surface 312b of elongate member 312. Typically, the upper and lower translucent layers 316, 315 are made of LEXAN, although any other suitable at least partially translucent material may be used.

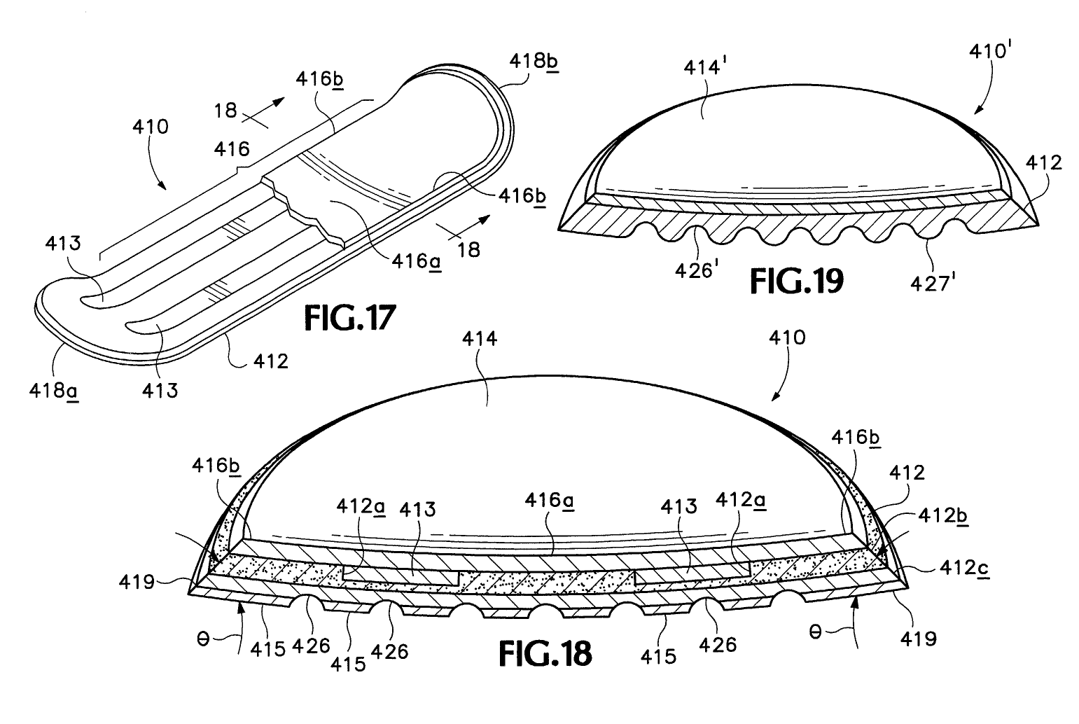

Turning now to FIGS. 17 and 18, a snow-gliding apparatus according to another embodiment of the present invention is shown generally at 410. Apparatus 410 typically includes an elongate member 412 configured to slide over snow and a traction member 414 configured to provide traction for the boots or shoes of a rider. Apparatus 410 typically includes an intermediate portion 416 and upturned end portions 418a, 418b similar to those described above. Intermediate portion 416 typically is upwardly laterally curved such that a central region 416a is depressed relative to side regions 416b.

Snow-gliding apparatus 410 further typically includes a plurality of stringers 413. Each stringer typically is placed into a corresponding channel 412a formed in elongate member 412. Stringers 413 are made of a resilient material, such as laminated wood, carbon fiber, or other material, and are configured to increase the longitudinal stiffness of elongate member 412 and cause apparatus 410 to keep its shape after repeated use. Stringers 413 usually are adhered to elongate member 412 within channels 412a with a suitable adhesive. Although U-shaped channels 412a are depicted, stringers 413 also may be positioned in completely enclosed channels that are O-shaped.

Elongate member 412 typically includes a plurality of layers, such as layer 412b and 412c. Typically, layer 412b is stiffer than layer 412c. The stiffness of layer 412b is achieved by adding talcum to the plastic (typically, high-density polyethylene, as described above). Typically, stiffer layer 412b is positioned above layer 412c, such that a downwardly applied bending stress by the feet of a rider is counteracted more efficiently. Alternatively, stiffer layer 412b may be placed below layer 412c.

Apparatus 410 further typically includes a lower translucent layer 415 configured to enable a user to view indicia printed on a bottom surface of elongate member 412, similar to that shown in FIG. 15. Alternatively, layer 415 may be a third layer of elongate member 412 having a different stiffness from layer 412b or 412c. Typically, layers 412b and 412c are produced by a co-extrusion manufacturing process. Alternatively, the layers may be laminated by means of adhesives, solvents, fasteners, or other suitable mechanisms, or formed in another suitable manner.

Apparatus 410 further includes beveled edges 419 formed along the length of the side of the elongate member. Beveled edges 419 typically are formed at an angle θ of between about 30- and 60-degrees. Alternatively, angle θ is between about 40- and 50-degrees, and is 45-degrees in a particularly preferred embodiment of the invention.

In FIG. 19, another embodiment of the present invention is shown at 410′. Apparatus 410′ is similar in construction to apparatus 410, except as otherwise described below. Apparatus 410′ has a traction member 414′ and an elongate member 412′. Elongate member 412′ includes a plurality of channels 426′ that meet in curved ridges 427′. Channels 426′ and ridges 427′ are formed in an undulatory, or corrugated shape, thereby giving strength to apparatus 410′.

While the present invention has been particularly shown and described with reference to the foregoing preferred embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. Where the claims recite “a” or “a first” element or the equivalent thereof, such claims should be understood to include incorporation of one or more such elements, neither requiring nor excluding two or more such elements.

I claim:

1. A gliding apparatus for use in snow, comprising:
an elongate member including an intermediate portion positioned between a pair of longitudinally opposed upturned end portions, the elongate member including a bottom surface configured to glide over snow, wherein the elongate member includes a laterally upwardly curved surface; and
a traction layer positioned above the elongate member.

2. The gliding apparatus of claim 1, wherein the laterally upwardly curved surface is a top surface of the elongate member.

3. The gliding apparatus of claim 1, wherein the laterally upwardly curved surface is the bottom surface of the elongate member.

4. The gliding apparatus of claim 1, wherein a lateral cross-section of the elongate member is upwardly curved.

5. The gliding apparatus of claim 1, further comprising a channel extending lengthwise at least partially along the bottom surface of the elongate member, the channel being configured to guide the elongate member over the s now.

6. The gliding apparatus of claim 5, wherein the channel is a first channel, further comprising a second channel extending lengthwise at least partially along the bottom surface of the elongate member.

7. The gliding apparatus of claim 1, wherein the traction layer is a pliant foam layer.

8. A gliding apparatus for use in snow, comprising:
an elongate member including an intermediate portion positioned between a pair of longitudinally opposed upturned end portions, the elongate member including a bottom surface configured to glide over snow; and
a stringer embedded in and extending lengthwise along the elongate member.

9. The gliding apparatus of claim 8, wherein the stringer is made at least partially of wood.

10. The gliding apparatus of claim 9, wherein the wood is laminated.

11. The gliding apparatus of claim 9, wherein the wood is pre-stressed.

12. The gliding apparatus of claim 8, wherein the stringer is made at least partially of a carbon filament material.

13. The gliding apparatus of claim 8, wherein the stringer is a first stringer, and the apparatus further comprises a second stringer imbedded in and extending lengthwise along the elongate member.

14. The gliding apparatus of claim 13, wherein each of the stringers extends from a leading to a trailing end of the elongate member.

15. The gliding apparatus of claim 8, further comprising a traction layer positioned above the stringer and elongate member.

16. A gliding apparatus for use in snow, the apparatus comprising:
an elongate member, including an intermediate portion positioned between a pair of longitudinally opposed upturned end portions, the elongate member including a bottom surface configured to glide over snow, the elongate member being formed of first and second layers of material, the first layer being stiffer than the second layer; and
a traction layer positioned above the elongate member.

17. The gliding apparatus of claim 16, wherein the first and second layers are co-extruded.

18. The gliding apparatus of claim 17, wherein the first and second layers are high-density polyethylene.

19. The gliding apparatus of claim 18, wherein the first layer includes a stiffener.

20. The gliding apparatus of claim 19, wherein the stiffener is talcum.

21. The gliding apparatus of claim 16, wherein the first layer is positioned below the second layer.

22. The gliding apparatus of claim 16, further comprising a third layer positioned adjacent the first and second layers, the third layer having a different stiffness from the first and second layers.

23. The gliding apparatus of claim 16, further comprising a channel extending lengthwise along the bottom surface of the elongate member, the channel being configured to guide the elongate member over snow.

24. A gliding apparatus for use on snow, the apparatus comprising:
an elongate member including an intermediate portion positioned between a pair of longitudinally opposed upturned end portions, the elongate member including indicia on a surface;
a translucent layer positioned adjacent the surface such that the indicia is visible through the translucent layer; and
a channel extending lengthwise along a bottom surface of the elongate member, the channel being configured to guide the apparatus over snow.

25. The apparatus of claim 24, wherein the indicia is on a top surface of the elongate member and the translucent is a traction layer positioned above the elongate member.

26. The apparatus of claim 25, wherein the traction layer includes a plurality of upward protrusions.

27. The apparatus of claim 24, wherein the indicia is on a bottom surface of the elongate member and the translucent is positioned below the elongate member.

28. The apparatus of claim 27, wherein the channel is carved into the translucent layer.

29. A gliding apparatus for use on snow, the apparatus comprising:
an elongate member including an intermediate portion positioned between a pair of upturned end portions, the elongate member including a bottom surface; and
a plurality of substantially parallel channels extending lengthwise along the bottom surface of the elongate member, adjacent channels being separated by rounded ridges extending therebetween.

30. The gliding apparatus of claim 29, wherein a cross-section of the channels and ridges has a substantially sinusoidal shape.

31. The gliding apparatus of claim 29, further comprising a traction layer positioned above the elongate member.

32. The gliding apparatus of claim 31, wherein the traction layer includes pliant foam.

33. A gliding apparatus for use on snow, the apparatus comprising:
an elongate member including an intermediate portion between a pair of upturned end portions, the elongate member including a bottom surface configured to glide over snow and a pair of opposed side edges, each of which tapers to a point at an angle of between about 30- and 60-degrees; and
a traction layer positioned above the elongate member.

34. The gliding apparatus of claim 33, further comprising a channel extending lengthwise along the bottom surface of the elongate member, the channel being configured to guide the elongate member over snow.

35. The gliding apparatus of claim 34, wherein the angle is formed between about 40- and 50-degrees.

36. The gliding apparatus of claim 35, wherein the angle is about 45-degrees.
